(19) United States
(12) Patent Application Publication
(10) Pub. No.: US 2026/0086344 A1
(43) Pub. Date: Mar. 26, 2026

(54) SYSTEM AND METHOD FOR IMAGE ENHANCEMENT OF REFLECTANCE CONFOCAL MICROSCOPES

(71) Applicant: TECHNION RESEARCH & DEVELOPMENT FOUNDATION LIMITED, Haifa (IL)

(72) Inventors: Dvir YELIN, Haifa (IL); Lidan FRIDMAN, Haifa (IL)

(21) Appl. No.: 19/118,863

(22) PCT Filed: Oct. 5, 2023
(86) PCT No.: PCT/IL2023/051063

§ 371 Date: Apr. 7, 2025

Related U.S. Application Data
(60) Provisional application No. 63/413,700, filed on Oct. 6, 2022.

(51) Int. Cl. G02B 21/36; G02B 21/00

(52) U.S. Cl. CPC G02B 21/367; G02B 21/0032; G02B 21/008

(57) ABSTRACT

A method of image enhancement of a reflectance confocal microscope is disclosed. The method comprises: receiving by a processor a first image captured by a detector of the confocal microscope, at a first position of a pinhole; receiving one or more second images captured by the detector, at at least one second position of the pinhole; and adding, by the processor, the one or more second images to the first image to reduce a speckle contrast in the combined image. In addition, the first position of the pinhole is a confocal position, and the at least one second position is a shifted position with respect to the confocal position.

### CROSS REFERENCE TO RELATED APPLICATIONS

This application claims the benefit of priority of U.S. Provisional Patent Application No. 63/413,700, filed Oct. 6, 2022, the contents of which are all incorporated herein by reference in their entirety.

### FIELD OF THE INVENTION

The present invention relates generally to confocal microscopy. More specifically, the present invention relates to image enhancement of reflectance confocal microscopes.

### BACKGROUND

In reflectance confocal microscopy (RCM) and other confocal-based applications, especially in the biomedical field where non-flourescence imaging of scattering biological tissues is conducted, speckle noise is one of the most limiting factors. Medical technologies that rely on confocal imaging can be found in fields such as opthalmology, dermathology, gastroentrology and hematology, where high-resolution imaging within thick tissue are crucial for accurate diagnosis. Another speckle-sensitive imaging modality that is based on RCM is optical coherence tomography (OCT), which has recently become important in numerous clinical fields due to its large imaging depths and high imaging rates.

Many attempts have been made in the past to address the speckle problem in confocal imaging, including adjustments of the diameter of the confocal pinhole, or alternatively of the optical fibers used in fiber-based RCMs. While pinhole opening could somewhat reduce the speckle contrast to some degree, the axial resolution often drops significantly, preventing effective imaging in thick samples. Other possible solutions for reducing speckles include increasing the numerical aperture, averaging under sample motion, using multiple wavelengths, and numerous approaches that rely on PSF engineering, for example by using beam shaping and other beam manipulations.

However, speckle is deterministic and therefore cannot be averaged as random image noise. Hence all of the current methods for reducing speckle require either changing the PSF or averaging over several images acquired at different conditions. However, most of these approaches severely reduce the imaging resolution, particularly the axial resolution, which is critical for most clinically relevant tissue imaging applications.

### SUMMARY

Some aspects of the invention are directed to a method of image enhancement of a reflectance confocal microscope, the method comprising: receiving by a processor a first image captured by a detector of the confocal microscope, at a first position of a pinhole; receiving one or more second images captured by the detector, at at least one second position of the pinhole; and adding, by the processor, the one or more second images to the first image to reduce a speckle contrast in the combined image. In some embodiments, the first position of the pinhole is a confocal position, and the at least one second position is a shifted position with respect to the confocal position.

In some embodiments, the at least one second image comprises pairs of images, wherein each of the images in each pair is captured with the pinhole shifted in a different direction. In some embodiments, the different directions are opposite directions along an axis passing through the confocal position of the pinhole.

In some embodiments, the at least one second position is a shifted position in a direction along a pinhole plane. In some embodiments, the at least one second position is a shifted position in a direction perpendicular to a pinhole plane. In some embodiments, the shifted position is of up to twice the diameter of the pinhole aperture. In some embodiments, the shifted position is of one diameter of the pinhole aperture. In some embodiments, the shifted position is of half a diameter of the pinhole aperture.

Some aspects of the present invention may be directed to a system for image enhancement of a reflectance confocal microscope, comprising: a reflectance confocal microscope with a shiftable pinhole; and a processor, configured to: receive a first image captured by a detector of the confocal microscope, at a first position of the pinhole; receive one or more second images captured by the detector, at at least one second position of the pinhole; and add the one or more second images to the first image to reduce a speckle contrast in the combined image. In some embodiments, the first position of the pinhole is a confocal position, and the at least one second position is a shifted position with respect to the confocal position.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows schematic of the simulated reflectance confocal microscope where the pinhole could be either centrally aligned or shifted at each lateral direction. The bottom-right panel shows an example of a pinhole that was shifted by a full aperture in the +x axis according to embodiments of the present invention;

FIG. 2a-2f is a simulation, according to some embodiments, of the confocal PSF with FIG. 2a centered pinhole, FIG. 2b pinhole shifted by a half diameter, and FIG. 2c pinhole shifted by a full diameter. The BL and R crosses mark the location of the maximum illumination field and the effective location of the pinhole center, respectively. FIG. 2d-Lateral cross section of the PSFs in FIGS. 2a-2c. FIG. 2e—Axial cross-sections of the PSFs in a-c through their maxima. FIG. 2f—The axial response computed by projecting the PSFs in FIGS. 2a-2c on the axial z axis according to embodiments of the present invention;

FIGS. 3a-3d show the step response of a pinhole-shifted confocal microscope, according to some embodiments; FIG. 3a shows the reflectivity target of a unit-reflectivity square; FIG. 3b shows simulated confocal image of the square target; FIG. 3c shows confocal image of the target using a pinhole shifted by a full aperture in the +x axis; and FIG. 3d shows an image generated by summation over four confocal images of the target, with the pinhole fully shifted in the ±x and ±y axes. Plots below the images present the horizontal cross sections and the corresponding derivatives, for illustrating the lateral step response according to embodiments of the present invention;

FIGS. 4a-4d show speckle reduction using four pinhole shifts, according to some embodiments. FIG. 4a shows the simulated sample volume, comprised of several individual scatterers; FIG. 4b shows conventional (centered pinhole) confocal image of the sample in (a) with the corresponding normalized histogram. FIG. 4c shows four confocal images acquired with pinhole shifted by a full aperture in ±x and ±y axes. The images shown are 4-times brighter to allow visual comparison to the centered-pinhole image presented at the center; and FIG. 4d shows a summation of the four pinhole-shifted images (2.2-times brightened), demonstrating speckle reduction from 0.58 to 0.37 and narrowing of the corresponding normalized histogram. The total signal loss was approximately 48% according to embodiments of the present invention;

FIGS. 5a-5d illustrate pinhole shifting for improving image quality of red blood cell, according to some embodiments. FIG. 5a shows the simulated membrane surfaces of the red blood cell. Parts of the membrane that are perpendicular to the focal plane are not shown; FIG. 5b is a simulated confocal image with no pinhole shifting; FIG. 5c shows the sum of four simulated confocal images, each with half-aperture shift in the ±x and ±y axes; and FIG. 5d shows the sum of four simulated confocal images, each with full-aperture shifts. Note the significant reduction in fringe contrast in (d) relative to (b). Central cross-sections of the images in (b)-(d) are shown below the confocal images for illustrating the reduction in fringe contrast according to embodiments of the present invention;

FIG. 6 shows high level block diagram of an exemplary computing device according to embodiments of the present invention; and

FIG. 7 is flowchart of a method of image enhancement according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A confocal microscope is considered perfectly aligned if the light-rejecting pinhole is positioned so as to maximize the signal reflected from the sample. In such case, the pinhole creates an affective collection region that overlaps the illumination region (hence the term “con-focal”). By shifting the collection pinhole, the speckle changes from its original distribution with a centered pinhole. Some embodiments of the invention outline a method for reducing the speckle by lateral shifting the confocal pinhole and acquiring multiple images for each pinhole location. While pinhole shifting may cause some loss of signal, it changes the speckle pattern of the image without significant reduction in resolution. The new speckle field may now be used to reduce the speckle contrast simply by adding the new image to the original image acquired with a centered pinhole. Furthermore, by shifting the pinhole in another direction, the newly formed speckle field is again different from the other speckle fields.

In some embodiments, a speckle reduction method that involves the acquisition of four images for four different shifts of the pinhole, in the −x, +x, −y and +y axes, where each shift was simulated by a full aperture (one diameter) of the pinhole. The image that resulted by adding the four images showed significantly reduced speckle when compared to the single central-pinhole image.

The technique may be used with shifting of the pinhole in any direction, i.e. in the lateral x-y plane and in the axial z axis, and with any amount, i.e. by half aperture, full aperture, and even more. Yet it appears that the tradeoff between speckle reduction and resolution (or signal) is optimal around a single full-aperture shift. A combination of symmetric shifts may be preferred in homogenous or isotropic samples, for avoiding image distortions. In inhomogeneous and/or anisotropic samples, other combinations of shifts may be optimal, for example, in a directional blood flow, where the cells are oriented mainly in one axis, only one or two shifts may be sufficient for reducing speckle or interference artifacts. Other applications with anisotropic samples that could benefit from pinhole shifting may be in the semiconductor industry, were an imaging modality with optical edge detection capabilities could improve the detection of defects for chip inspection.

In some embodiments, the speckle-reduced image data may be combined, for example by post processing, with the centered-pinhole image, taking advantage of the complementary properties of each modality (low speckle combined with the original sharper and brighter image).

In some embodiments, pinhole shifting is done relative to the illumination beam, where the zero-shift point is determined so that the central point of pinhole virtual image exactly overlaps the central point of the of the 3D illumination field. Therefore, a similar effect may be achieved if the illumination field is physically shifted relative to the collection field (i.e. the virtual image of the pinhole). Thus, everything that was mentioned above is valid for illumination shifting as well, including the four full-aperture shifts. One means for shifting the illumination is to change the angle of the illumination beam before the objective lens.

Some aspects of the invention are directed to a method for speckle reduction by using simple lateral shifting of the confocal pinhole in several directions, which results in reduced speckle contrast and only a moderate penalty in both lateral and axial resolutions. In some embodiments, by simulating free-space electromagnetic wave propagation through a high-NA confocal imaging system, and assuming only single-scattering events, a 3D PSF that results from full-aperture pinhole shifting may be characterized. A simple summation of four different pinhole-shifted images had resulted in 36% reduction in speckle contrast with only 17% and 60% reduction in the lateral and axial resolutions, respectively.

This method may be particularly useful in noninvasive microscopy for clinical diagnosis, where fluorescence labelling is impractical and high image quality is imperative for achieving accurate diagnosis.

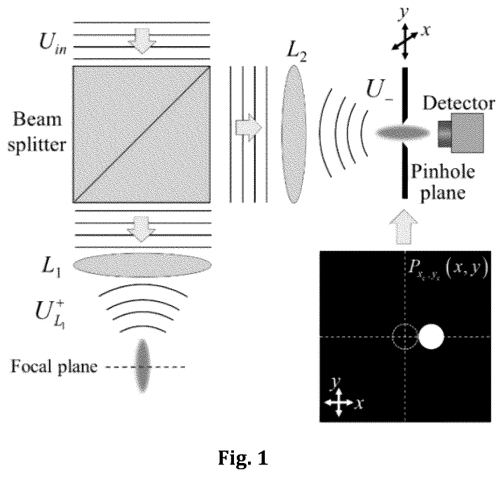

Embodiments of the present invention provide a method and system for reducing the speckle contrast in RCM by means of capturing a plurality of images (e.g., four images) with different laterally shifted pinholes. By simulating the full optical system of a confocal microscope (FIG. 1), including both the illumination and collection optical paths, it may be shown that lateral shifting of the detection pinhole largely preserves the axial and lateral resolutions of the system, while reducing the overall speckle noise by averaging over the (e.g., four) pinhole-shifted images.

In order to study the effect of lateral pinhole shifting, the point-spread function (PSF) of a high-NA confocal microscope may be simulated (FIG. 1). A unit-amplitude plane wave Uᵢₙ at 800 nm wavelength was simulated using 4097×4097-pixel grid covering a square area of 300×300 μm², resulting in pixel size equals to 0.0732 μm that allows sufficient 10-pixel sampling of the illumination PSF (approximately 0.73 μm).

For simulating an ideal high-NA objective lens with NA=0.7, the lens L₁ may be chosen with a small pupil diameter D equals to 40 μm, a focal length f equals to 20.4 μm, and a transfer function with a hyperboloidal phase delay given by:

$${U}_{{L}_{1}}^{+} ( x , y ) = {P}_{{L}_{1}} ( x , y ) exp ( - i k ( \sqrt{{f}^{2} + {x}^{2} + {y}^{2}} - f ) ) , \qquad ( 1 )$$

where k=2π/λ, λ denotes the optical wavelength and P_{L1}(x,y) denotes the lens pupil function. At the focal region the illuminating wave Uᵢₗₗ was simulated for each propagation distance z using the free-space wave propagation equation (i.e. without using the Fresnel approximation).

In some embodiments, a full PSF of the confocal microscope was computed by considering a single-point unit-amplitude reflector at the focal region of the illumination wave. By using the same free-space propagation equation, the reflected wave was propagated back through the objective lens (using Eq. 1) and then focused onto the pinhole plane through the lens L₂, whose pupil and phase transfer functions are similar to those of the objective lens L₁.

Once the optical wave U₋ just before the pinhole plane was computed, the confocal pinhole itself may be simulated as a clear circular aperture with diameter a equals to the illumination spot size a=0.73 μm (equivalent to a 10-pixel-diameter), whose center coordinates (x_{c},y_{c}) could be varied for simulating the lateral shifting of the pinhole:

$${P}_{{x}_{c} , {y}_{c}} ( x , y ) = \{ \begin{matrix}1 , & {( x - {x}_{c} )}^{2} + {( y - {y}_{c} )}^{2} \leq {( a / 2 )}^{2} \\ 0 , & else\end{matrix} . \qquad ( 2 )$$

After the pinhole, the total transmitted field intensity I_{d} was measured simply by summing over the local intensity of the wave U₋ passing through the pinhole aperture:

$${I}_{d} = {\sum }_{x , y} {P}_{{x}_{c} , {y}_{c}} ( x , y ) {\vert {U}_{-} ( x , y ) \vert}^{2} . \qquad ( 3 )$$

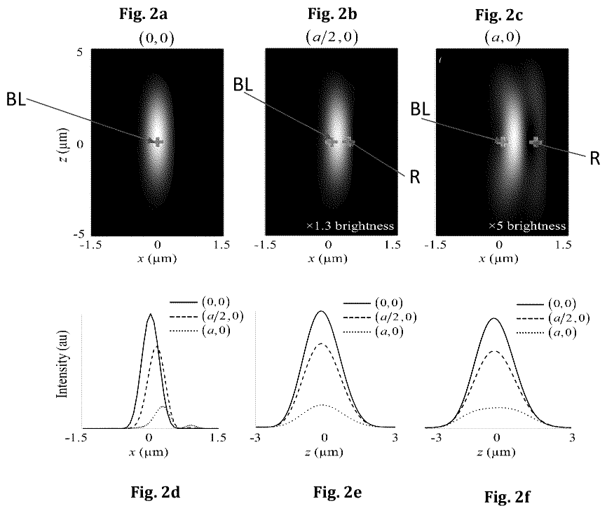

In some embodiments, by scanning the point reflector across the entire focal volume, the 3D confocal PSF may be obtained for a centered (x_{c}=y_{c}=0) pinhole (FIG. 2a), for pinhole shifted by a half aperture diameter (x_{c}=a/2, y_{c}=0) (FIG. 2b) and for a pinhole shifted by a full aperture (x_{c}=a, y_{c}=0) (FIG. 2c). Lateral and axial cross-sections of the three PSFs through their peak values are shown in FIGS. 2d and 2e, respectively.

In some embodiments, the conventional (centered pinhole) PSF had a width and an axial range of 0.44 μm (FWHM) and 1.83 μm (FWHM), respectively, in close agreement with the theoretical lateral and axial resolutions of 0.42 μm and 2.08 μm, respectively. The slight differences between the numerical simulation and theory are most likely a result of the limited digital sampling of the optical waves.

In some embodiments, as the pinhole center point (x_{c},y_{c}) is laterally shifted, the illumination and collection regions do not overlap anymore, resulting in an overall reduction in the detected signal, as well as lateral shifting of the confocal peak-response. Half-aperture pinhole shifting had led to approximately quarter-aperture PSF shift in the same direction (FIG. 2b), where full-aperture pinhole shifting had led to approximately half-aperture PSF shift (FIG. 2c). Note that in the shifted, asymmetric PSFs both the lateral and axial widths were almost unaffected: in full-pinhole shifting the lateral resolution was even slightly improved by 11% down to 0.39 μm (albeit with a notable side-lobe on the righthand side), while the axial resolution was dropped by only 10% to 2.02 μm, as calculated along an axial section passing through the PSF peak response (FIG. 2e). A more notable drop in the axial resolution could be calculated by laterally projecting the PSF shown in FIG. 2c on the axial z axis, resulting in somewhat lower axial resolutions of 1.88 μm, 2 μm and 3 μm for the centered, half-aperture and full-aperture shifted pinholes, respectively (FIG. 2f).

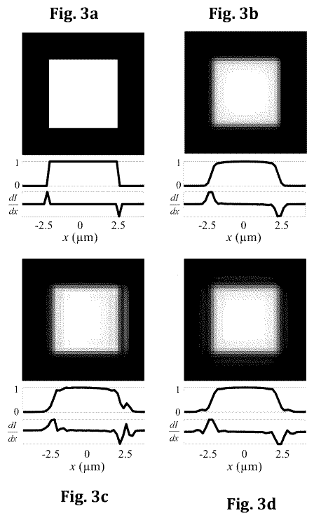

In some embodiments, the step response of the simulated microscope for centered and fully shifted pinholes was estimated by simulating a reflection target comprised of a single reflective square (FIG. 3a). The simulated confocal image with a centered pinhole showed some blurring and contrast reduction (FIG. 3b), with lateral edge response of 0.53 μm (FWHM), somewhat larger than the lateral size (0.44 μm) of the simulated PSF. A single image captured with a full (x_{c}=a) lateral shift of the pinhole (FIG. 3c) showed notable asymmetric response with pronounced sidelobe on the righthand side of the square, in agreement with the PSF sidelobe in FIG. 2c.

In some embodiments, removing the asymmetry in FIG. 3c may be accomplished by averaging over several images acquired with pinhole shifting in opposite directions. In order to demonstrate such concept, the acquisition of four confocal images may be simulated with pinhole shifted by a full aperture in the ±x and ±y directions. By averaging over these four images a symmetric image may be obtained of the reflective square (FIG. 3d), with edge response equals 0.62 μm (FWHM), which is only 17% larger than with the centered pinhole (FIG. 3b).

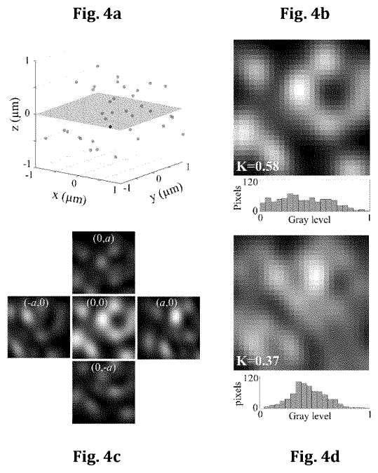

In some embodiments, in order to study the potential of the pinhole shifting method to reduce speckle contrast in an arbitrarily distributed scatterer field, a random 3D distribution of point scatterers within a cubic volume of 8 μm³ (FIG. 4a) was generated, and the acquisition of a single confocal image with the focal plane positioned at z=0 (grey plane in FIG. 4a) was simulated. Note that this simplistic model is not intended to simulate the effect of out-of-focus scatterers on the confocal image (i.e. resolution drop and background speckle), but rather to model the main speckle field formed only by the scatterers at the focal volume. To save computation times, only scatterers within a 1.5-μm-diameter cylinder around each pixel were considered. Each scatterer within this volume generated a single backward propagating wave (i.e. “single scatter”), and the interference between all reflected waves was spatially filtered by the pinhole and measured by the detector (Eq. 3).

In some embodiments, with no pinhole shifting, the resulting conventional image (FIG. 4b) showed a highly developed speckle field with 0.58 speckle contrast, computed as the ratio between the image standard deviation and the mean intensity. Four additional images were then captured with xc=−a (FIG. 4c, left panel), xc=a (right panel), yc=a (top panel) and yc=−a (bottom panel). A simple summation of the four images have resulted in a smoother image (FIG. 4d, 2.2-times brightened) with significantly lower speckle contrast of 0.37 and a total signal loss of only 48%. The reduction in speckle contrast is also evident by the narrower image histogram (lower panel of FIG. 4d).

In some embodiments, at clinical applications of RCM, such as spectrally encoded flow cytometry (SEFC) where in vivo noninvasive microscopy of blood cells is used for clinical diagnosis, the characteristic speckle may be often manifested by high-contrast interference patterns of arcs and rings. These patterns, which originate from the unique morphology of the red blood cells during flow, significantly deteriorate the image quality and prevent accurate segmentation and counting of individual cells.

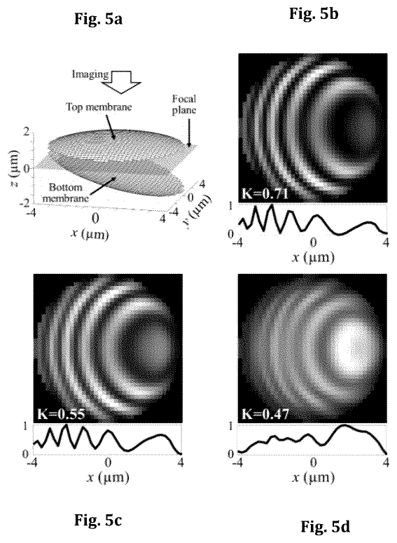

In some embodiments, in order to simulate the potential effect of pinhole shifting on the confocal SEFC images of the red cells, the cell membranes were modeled (FIG. 5a) using two opposing oblate spheroids with a uniformly distributed reflection coefficients, as described previously in Ref. Confocal imaging of the cell was simulated by scanning the focal region across the focal plane (grey plane at z=0), resulting in two reflections from the front and back surfaces, whereas the membrane curvatures and relative angles are embedded within the two reflected wavefronts. Using a centered pinhole, the conventional confocal image of the red cell (FIG. 5b) is characterized by several high-contrast, concentric interference arcs. Shifting the pinhole by a half aperture in the ±x and ±y axes and summing over the four images, resulted in some reduction of fringe contrast (FIG. 5c) from 0.71 to 0.55. Using full-aperture shifts, the resulting summation of the four images showed (FIG. 5d) significant reduction in fringe contrast to 0.47, and the entire image is now smoother and represents more closely the uniform round shape of the cell plasma membranes. Cross sections of the simulated images in 5b-c at y=0 are shown below the images to better illustrate the reduction in fringe contrast.

The simulation results are presented in FIGS. 3-5 demonstrate that the technique of pinhole shifting could reduce speckle contrast in RCM without significantly damaging the resolution according to some embodiments of the invention. The technique has several limitations though, which stem mostly from the less efficient light collection through the shifted pinhole. A single image acquired with a full-aperture shifting resulted in an average signal drop of 84%-92% for the reflective square target (FIG. 3c) and the scattering sample (FIG. 4c), and a less significant drop of approximately 63% in the simulated red blood cell (image not shown). By capturing four images in the method explained above (see FIGS. 3d, 4d and 5d) the signal loss was significantly reduced to 71% and 48% for the reflective square and the scattering sample, respectively, and was even increased by 46% in the case of the red blood cell (FIG. 5d).

In some embodiments, capturing the additional images would require larger complexity of the optical setup and additional time for shifting the pinhole and acquiring all the necessary images. Several approaches for improving the overall signal and reducing acquisition times may include scanning the collection optical path instead of moving the pinhole itself, using 4-pinhole mask and splitting the transmitted light to four detectors, and using different numbers of pinholes in different configurations that would better fit a specific task. Note that any pinhole configuration may obviously exhibit resolution and speckle contrast drops different from the results presented above.

In some embodiments, implementing the pinhole-shifting technique in commercially available confocal microscopes is, unfortunately, not a straight-forward task, mainly because most microscopes do not allow easy access to the pinhole. Other systems may better benefit from this technique, for example the optical-fiber based SEFC systems that rapidly generates reflectance confocal images of flowing blood cells in patients. For such application, any reduction of the speckle or fringe contrast (as in FIG. 5) could be significant for improving cell segmentation and counting.

In some embodiments, a new method of PSF engineering, was suggested, in reflectance confocal microscopy for reducing the speckle contrast with relatively small drop in resolution. By simulating the PSF of an RCM with the pinhole shifted by a full aperture, it may be shown that the PSF largely maintains its lateral and axial dimensions. By acquiring four different images at four different pinhole shifts, the resulting image showed reduced speckle contrast by 36%, with a relatively small damage to both lateral and axial resolutions. The proposed pinhole-shifting technique could assist many RCM-based imaging systems whose performance are hindered by speckle noise.

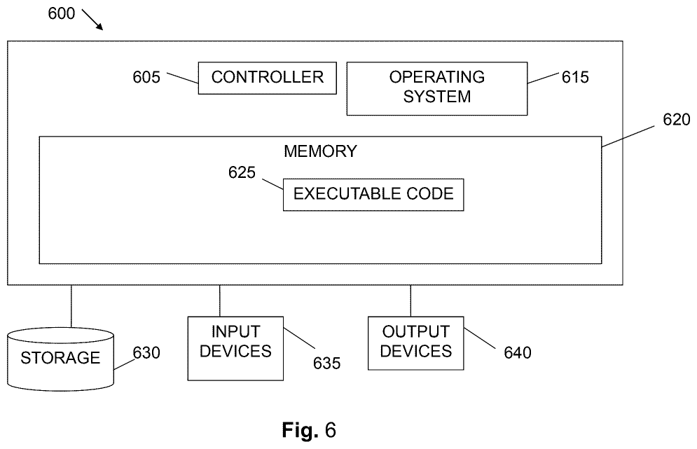

Reference is made to FIG. 6, showing a high-level block diagram of an exemplary computing device according to embodiments of the present invention. Computing device 600 may include a controller 605 that may be, for example, a central processing unit processor (CPU), a chip or any suitable computing or computational device, an operating system 615, a memory 620, an executable code 625, a storage 630, input devices 635 and output devices 640. Controller 605 may be configured to carry out methods described herein, and/or to execute or act as the various modules, units, etc. More than one computing device 600 may be included, and one or more computing devices 600 may act as the various components. For example a confocal microscope described herein may be, or may include components of, computing device 600. For example, by executing executable code 625 stored in memory 620, controller 605 may be configured to carry out a method of enhancing images of a confocal microscope as described herein. For example, controller 605 may be configured to receive images from a detector of the confocal microscope, obtained in different positions of the pinhole and use the received images to reduce speckle contrast by adding the images to the image captured at the confocal position of the pinhole as described herein.

Operating system 615 may be or may include any code segment (e.g., one similar to executable code 625 described herein) designed and/or configured to perform tasks involving coordination, scheduling, arbitration, supervising, controlling or otherwise managing operation of computing device 600, for example, scheduling execution of software programs or enabling software programs or other modules or units to communicate. Operating system 615 may be a commercial operating system.

Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different memory units. Memory 620 may be a computer or processor non-transitory readable medium, or a computer non-transitory storage medium, e.g., a RAM.

Executable code 625 may be any executable code, e.g., an application, a program, a process, task or script. Executable code 625 may be executed by controller 605 possibly under control of operating system 615. For example, executable code 625 may be an application that receives images from the detector of a confocal microscope and combine them into a single enhanced image as further described herein. Although, for the sake of clarity, a single item of executable code 625 is shown in FIG. 6, a system according to embodiments of the invention may include a plurality of executable code segments similar to executable code 625 that may be loaded into memory 620 and cause controller 605 to carry out methods described herein.

Storage 630 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 630 and may be loaded from storage 630 into memory 620 where it may be processed by controller 605. In some embodiments, some of the components shown in FIG. 6 may be omitted. For example, memory 620 may be a non-volatile memory having the storage capacity of storage 630. Accordingly, although shown as a separate component, storage 630 may be embedded or included in memory 620.

Input devices 635 may be or may include a detector of a confocal microscope, a mouse, a keyboard, a touch screen or pad or any suitable input device. It will be recognized that any suitable number of input devices may be operatively connected to computing device 600 as shown by block 635. Output devices 640 may include one or more displays or monitors, speakers and/or any other suitable output devices. It will be recognized that any suitable number of output devices may be operatively connected to computing device 600 as shown by block 640. Any applicable input/output (I/O) devices may be connected to computing device 600 as shown by blocks 635 and 640. For example, a wired or wireless network interface card (NIC), a printer, a universal serial bus (USB) device or external hard drive may be included in input devices 635 and/or output devices 640.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 620, computer-executable instructions such as executable code 625 and a controller such as controller 605.

Some embodiments may be provided in a computer program product that may include a non-transitory machine-readable medium, stored thereon instructions, which may be used to program a computer, controller, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 620 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 605), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 600.

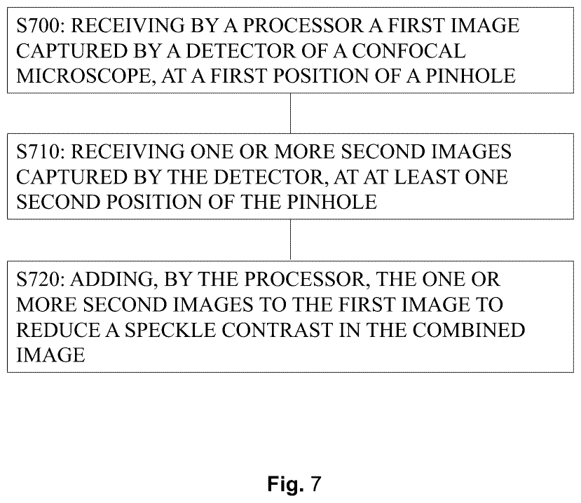

Reference is now made to FIG. 7 which is a flowchart of a method according to embodiments of the present invention. In step S700 a processor of a computing device such as computing device 600 may receive an image captured by a detector of a confocal microscope, in a first, confocal position. The term confocal position may refer to, in the scope of this application, a position in which the light-rejecting pinhole is positioned so as to maximize the signal reflected from the sample. In such case the pinhole creates an effective collection region that overlaps the illumination region.

In step S710, the processor may receive at least one additional image captured by the detector, at at least a second, shifted position of the pinhole. According to some embodiments, the shift may be in the size of a part of the pinhole aperture, a full size of the aperture, or even more than one pinhole aperture. The shift may be in any direction, as detailed above and discussed with respect to FIGS. 1, 2, 3a, 3b, 3c and 3d.

In some embodiments, the at least one additional image comprises pairs of images, wherein each of the images in each pair is captured with the pinhole shifted in a different direction. In some embodiments, the different directions are opposite directions along an axis passing through the confocal position of the pinhole.

In some embodiments, the at least one second position is a shifted position in a direction along a pinhole plane. In some embodiments, the at least one second position is a shifted position in a direction perpendicular to a pinhole plane. In some embodiments, the shifted position is of up to twice the diameter of the pinhole aperture. In some embodiments, the shifted position is of one diameter of the pinhole aperture. In some embodiments, the shifted position is of half a diameter of the pinhole aperture.

In step S720, the processor may add the one or more second images to the first image, to reduce a speckle contrast in the combined image, with respect to the speckle contrast in the first image. For example, the images in FIGS. 3-5 discussed above, demonstrate a technique of pinhole shifting that may reduce speckle contrast in RCM without significantly damaging the resolution.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of image enhancement of a reflectance confocal microscope, the method comprising:
receiving by a processor a first image captured by a detector of the confocal microscope, at a first position of a pinhole;
receiving one or more second images captured by the detector, at at least one second shifted position of the pinhole; and
adding, by the processor, the one or more second images to the first image to reduce a speckle contrast in the combined image,
wherein the first position of the pinhole is a confocal position, and
wherein the at least one second position is a shifted position with respect to the confocal position.

2. The method according to claim 1, wherein the at least one second image comprises pairs of images, wherein each of the images in each pair is captured with the pinhole shifted in a different direction.

3. The method according to claim 2 wherein the different directions are opposite directions along an axis passing through the confocal position of the pinhole.

4. The method according to claim 1, wherein the at least one second position is a shifted position in a direction along a pinhole plane.

5. The method according to claim 1, wherein the at least one second position is a shifted position in a direction perpendicular to a pinhole plane.

6. The method according to claim 1, wherein the shifted position is of up to twice the diameter of the pinhole aperture.

7. The method according to claim 1, wherein the shifted position is of one diameter of the pinhole aperture.

8. The method according to claim 1, wherein the shifted position is of half a diameter of the pinhole aperture.

9. A system for image enhancement of a reflectance confocal microscope, comprising:
a reflectance confocal microscope with a shiftable pinhole; and
a processor, configured to:
receive a first image captured by a detector of the confocal microscope, at a first position of the pinhole;
receive one or more second images captured by the detector, at at least one second position of the pinhole; and
adding the one or more second images to the first image to reduce a speckle contrast in the combined image,
wherein the first position of the pinhole is a confocal position, and
wherein the at least one second position is a shifted position with respect to the confocal position.
